(19) United States
(12) Patent Application Publication
(10) Pub. No.: US 2026/0134210 A1
(43) Pub. Date: May 14, 2026

(54) SYSTEM PROMPT HARDENING AND VALIDATION

(71) Applicant: Intuit Inc., Mountain View, CA (US)

(72) Inventors: Idan HABLER, Jerusalem (IL); Itsik Yizhak MANTIN, Shoham (IL); Guy SHTAR, Ness Ziona (IL); Itay HAZAN, Be'er Sheva (IL)

(73) Assignee: Intuit Inc., Mountain View, CA (US)

(21) Appl. No.: 18/946,916

(22) Filed: Nov. 13, 2024

(51) Int. Cl. G06F 40/226; G06F 16/332

(52) U.S. Cl. CPC G06F 40/226; G06F 16/3329

(57) ABSTRACT

Systems and methods for hardening and/or validating a system prompt are disclosed herein. An example validation method is performed by one or more processors of a computing system. The example method may include receiving a transmission including a full prompt over a communications network from an application, the full prompt including a system prompt associated with the application and a user prompt from a user of the application, determining whether the system prompt conforms to an expected prompt for the application, and selectively transmitting the full prompt to a language model (LM) based on whether the system prompt conforms to the expected prompt, the selective transmission including transmitting the full prompt to the LM responsive to determining that the system prompt conforms to the expected prompt, and refraining from transmitting the full prompt to the LM responsive to determining that the system prompt does not conform to the expected prompt.

### TECHNICAL FIELD

This disclosure relates generally to hardening and/or validating system prompts for language models, and specifically to automated system prompt hardening and validation.

### DESCRIPTION OF RELATED ART

Artificial intelligence (AI) refers to the development of computer systems that can perform tasks traditionally requiring human intelligence, such as learning, problem-solving, and decision-making. Many computer-based applications now integrate AI to improve functionality and user experience, including applications used in fields such as healthcare, automation, personal assistants, recommendation systems, data analysis, among others. For instance, many applications rely on AI-based language models (LMs) (including large language models (LLMs)) to generate responses based on input data (e.g., from users), to conduct natural language processing (NLP) tasks, or to provide users with automated decision-making capabilities. Applications that incorporate LMs generally provide the LM with a system prompt (or “metaprompt”) before providing the LM with the user’s query (or “user prompt”). The system prompt may include instructions, guidelines, and/or contextual information that set operational boundaries for the LM, define its output requirements, and/or establish “guardrails” that dictate what the LM should or should not do under various circumstances.

However, such applications are vulnerable to several types of attacks. Example attack types include closed-domain prompt injection, open-domain misaligned attacks, open-domain aligned attacks, system message extraction attacks, prompt leaking, jailbreaking, universal adversarial triggers, phishing URL injections, input manipulation, information disclosure attacks, context confusion attacks, etc., and each attack type may be executed in many different ways or using many different techniques or approaches (referred to as “attack vectors”). With respect to phishing URL injection attacks, some systems have seen success in modifying the system prompt to include certain text-based guardrails that prevent the inclusion of URLs or restrict certain types of content, thereby causing the LM to refuse to generate outputs containing the malicious URLs.

Because particular text guardrails can be helpful for particular scenarios, some systems have attempted to incorporate an exhaustive list of guardrails into their system prompts that accounts for every possible attack type and scenario. However, such an approach is impractical because, in general, increasing the system prompt size has been shown to lead to a decrease in the LM’s accuracy and performance. Specifically, because LMs tend to struggle to adhere to extensive lists of constraints and/or requests, excessively detailed system prompts tend to overwhelm LMs, causing them to prioritize guardrail compliance over user prompt execution, thus defeating the user’s purpose of using the application. Additionally, although some systems have used adversarial learning methods to train LMs to recognize and resist specific adversarial inputs, this approach is generally inefficient, difficult to scale, and complex (i.e., time consuming and expensive), particularly when applications need protection against many different threats.

Further yet, some systems manage many different applications, and thus many different system prompts may be used. For instance, each application developer may be required to append a particular system prompt to the user prompt when a query is sent to the LM. However, at this time, many issues may still occur, such as the application mistakenly appending the wrong system prompt (e.g., an outdated version), a malicious actor interfering (e.g., by attempting to alter the system prompt), or an incomplete data transmission (e.g., due to broken packets), any of which can lead to an incomplete or compromised prompt being sent to the LM. Thus, even when developers identify (e.g., through trial-and-error) an effective system prompt for their particular use case, the functionality of their applications may still be undermined in various ways, and thus, the security of the LMs and associated user information remains at-risk.

What is needed is a system that can provide automated and robust system prompt hardening and/or validation.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

One innovative aspect of the subject matter described in this disclosure can be implemented as a method for validating a system prompt. An example method is performed by one or more processors of a computing system and can include receiving a transmission including a full prompt over a communications network from an application, the full prompt including a system prompt associated with the application and a user prompt from a user of the application, determining whether the system prompt conforms to an expected prompt for the application, and selectively transmitting the full prompt to a language model (LM) based on whether the system prompt conforms to the expected prompt, the selective transmission including transmitting the full prompt to the LM responsive to determining that the system prompt conforms to the expected prompt, and refraining from transmitting the full prompt to the LM responsive to determining that the system prompt does not conform to the expected prompt.

Another innovative aspect of the subject matter described in this disclosure can be implemented in a computing system for validating a system prompt. An example system includes one or more processors and at least one memory coupled to the one or more processors and storing instructions that, when executed by the one or more processors, cause the system to perform operations. The operations can include receiving a transmission including a full prompt over a communications network from an application, the full prompt including a system prompt associated with the application and a user prompt from a user of the application, determining whether the system prompt conforms to an expected prompt for the application, and selectively transmitting the full prompt to an LM based on whether the system prompt conforms to the expected prompt, the selective transmission including transmitting the full prompt to the LM responsive to determining that the system prompt conforms to the expected prompt, and refraining from transmitting the full prompt to the LM responsive to determining that the system prompt does not conform to the expected prompt.

Another innovative aspect of the subject matter described in this disclosure can be implemented as a non-transitory computer-readable medium storing instructions that, when executed by one or more processors of a system for validating a system prompt, cause the system to perform operations. Example operations include receiving a transmission including a full prompt over a communications network from an application, the full prompt including a system prompt associated with the application and a user prompt from a user of the application, determining whether the system prompt conforms to an expected prompt for the application, and selectively transmitting the full prompt to an LM based on whether the system prompt conforms to the expected prompt, the selective transmission including transmitting the full prompt to the LM responsive to determining that the system prompt conforms to the expected prompt, and refraining from transmitting the full prompt to the LM responsive to determining that the system prompt does not conform to the expected prompt.

Another innovative aspect of the subject matter described in this disclosure can be implemented as a method for hardening a system prompt. An example method is performed by one or more processors of a computing system and can include receiving, over a communications network, a transmission including a set of soft system prompts, each soft system prompt associated with one of a plurality of experiences, transforming each soft system prompt into a corresponding hardened system prompt, each hardened system prompt including at least one mandatory portion predicted to reduce a success rate of an attack on an LM by more than a threshold when the at least one mandatory portion is included with instructions to the LM prior to the attack, and generating a guardrail database including an expected prompt for each corresponding experience based on each hardened system prompt.

Another innovative aspect of the subject matter described in this disclosure can be implemented in a computing system for hardening a system prompt. An example system includes one or more processors and at least one memory coupled to the one or more processors and storing instructions that, when executed by the one or more processors, cause the system to perform operations. The operations can include receiving, over a communications network, a transmission including a set of soft system prompts, each soft system prompt associated with one of a plurality of experiences, transforming each soft system prompt into a corresponding hardened system prompt, each hardened system prompt including at least one mandatory portion predicted to reduce a success rate of an attack on an LM by more than a threshold when the at least one mandatory portion is included with instructions to the LM prior to the attack, and generating a guardrail database including an expected prompt for each corresponding experience based on each hardened system prompt.

Another innovative aspect of the subject matter described in this disclosure can be implemented as a non-transitory computer-readable medium storing instructions that, when executed by one or more processors of a system for hardening a system prompt, cause the system to perform operations. Example operations include receiving, over a communications network, a transmission including a set of soft system prompts, each soft system prompt associated with one of a plurality of experiences, transforming each soft system prompt into a corresponding hardened system prompt, each hardened system prompt including at least one mandatory portion predicted to reduce a success rate of an attack on an LM by more than a threshold when the at least one mandatory portion is included with instructions to the LM prior to the attack, and generating a guardrail database including an expected prompt for each corresponding experience based on each hardened system prompt.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example computing system, according to some implementations.

FIG. 2 shows an example process flow for hardening and validating a system prompt, according to some implementations.

FIG. 3 shows an example process flow for hardening a system prompt, according to some implementations.

FIG. 4 shows an example process flow for validating a system prompt, according to some implementations.

FIG. 5 shows an illustrative flowchart depicting an example operation for validating a system prompt, according to some implementations.

FIG. 6 shows an illustrative flowchart depicting an example operation for hardening a system prompt, according to some implementations.

Like numbers reference like elements throughout the drawings and specification.

### DETAILED DESCRIPTION

As described above, many modern artificial intelligence (AI)-based systems and applications integrate language models (LMs) (e.g., large language models (LLMs), multimodal large language models (MLLMs), and the like) for tasks like natural language processing (NLP) and automated decision making. However, such systems and applications are vulnerable to numerous attack types, (e.g., prompt injection, phishing, information disclosure, adversarial manipulation, and the like), which may exploit various weaknesses in the LMs and compromise its responses. Incorporating exhaustive lists of comprehensive guardrails into system prompts tends to degrade the LM’s accuracy and effectiveness, and even system prompts well-refined for particular applications often face security and privacy issues when prompt mismatches, malicious interference, and/or transmission errors occur before the final prompt reaches the LM. To address these challenges, a system is needed that offers automated and robust methods for hardening and/or validating system prompts, thereby ensuring reliable and secure performance for AI-based systems and applications that integrate LMs.

Aspects of the present disclosure provide innovative systems and methods for automated hardening and/or validation of system prompts. The various systems and methods disclosed herein can be deployed to proactively defend AI-based systems and/or applications that integrate LMs and enhance their security, reliability, and user experience. For purposes of discussion herein: an “attacker” or “adversary” refers to any entity or mechanism that actively attempts to exploit or compromise the integrity of an LM or its associated application or system; a “threat” is a type of attack or outcome that an attacker seeks to achieve, such as the injection of a phishing URL (a “phishing URL injection attack”), extraction of the system prompt (a “prompt extraction attack”), or any other malicious objective that undermines the LM’s functionality; “attack vectors” are any method, technique, or approach an attacker may use in an attempt to achieve the intended threat; a “guardrail” is a protective measure incorporated into a system prompt (e.g., in the form of text instructions) intended to reduce a likelihood that an attack vector will succeed in achieving the associated threat; an “application” is an AI-based system or application that integrates, or is otherwise communicably coupled to, one or more LMs that perform particular tasks or functions for the application; an “experience” is a particular use case or instance within an application, where an application may have any number of experiences, and each experience may use its own system prompt (and/or LM) for its particular use case; a “soft system prompt” is a system prompt that is predicted to be vulnerable to one or more attacks due to a lack of robustness; “hardening” a (soft) system prompt includes increasing its robustness and reducing its predicted vulnerability to attacks; and “validating” a system prompt includes ensuring that and/or enforcing the conformance of a system prompt with determined standards and requirements before the system prompt is provided to the LM.

A computing system may be used to perform the various operations of the systems and methods disclosed herein. The computing system may be a hardening system, a validation system, or a hardening and validation system. In various implementations, the hardening and/or validation system may be integrated as part of a developer environment, an application, an AI firewall, and/or an LM. As an example, in various implementations, the hardening system may be implemented in an offline (or “buildtime” or “evaluation”) environment, such as for use by developers. As another example, in various implementations, the validation system may be implemented as or in an AI firewall communicably coupled between an application and an LM, such as for use in a runtime (or “real-time”) prompting scenario or environment. In various implementations, the hardening system receives one or more soft system prompts, where each soft system prompt may be associated with a particular experience provided by an application integrated with an LM. In accordance with the innovative techniques disclosed herein, the hardening system may transform each soft system prompt into a hardened system prompt, where each hardened system prompt may include at least one mandatory portion determined based on one or more simulated attacks on the LM. Specifically, the mandatory portion may be predicted to reduce a success rate of an attack on the LM when incorporated as a guardrail in a system prompt associated with the particular experience. In some implementations, the hardening system may repeat the above process for a plurality of soft system prompts associated with a plurality of experiences, and generate a guardrail database including an expected prompt for each experience based on the hardened system prompts. In various other implementations, the validation system receives a full prompt from an application integrated with an LM, where the full prompt includes a system prompt associated with the application and a user prompt from a user of the application. In accordance with the innovative techniques disclosed herein, the validation system determines whether the system prompt conforms to an expected prompt for the application. In some implementations, the expected prompt is stored in a guardrail database generated by the hardening system. The validation system may selectively provide the full prompt to the LM based on whether the system prompt conforms to the expected prompt. The various systems and methods disclosed herein may be deployed individually or in any combination.

In these and other manners, the computing system(s) described herein provide several technical benefits over conventional solutions for hardening and/or validating system prompts. By enabling automated techniques for hardening system prompts, the system increases the robustness of the system prompts, thwarts potential attacks, and assists engineers and developers with refining prompt quality for optimal LM performance. By enabling automated techniques for validating system prompts, the system enhances security and increases the integrity of system prompts during transmission of the system prompts and execution of the system prompts by the associated LMs. By enabling automated techniques for hardening and validating system prompts, the system increases security, enables dynamic updating of guardrails, and enforces the use of appropriate prompts for managed applications. By quantitatively determining the robustness of a system prompt that may be provided to an LM, the system provides an environment for evaluating and testing prompt resilience against various attack vectors, thereby allowing adaptable defenses against new threats. By automatically increasing the robustness of a system prompt and/or providing suggestions for increasing the robustness of the system prompt, the system assists engineers in refining prompts and increases security against a wide range of attack techniques. By selectively choosing the quantitatively most effective guardrails for a system prompt, the system prevents overwhelming LMs with exhaustive constraints so that the LM can focus more of its attention on the user prompt. By validating that system prompts are as robust as possible while considering a broad list of threats and mitigations, the system increases the robustness of prompts, thwarts potential attacks, and enforces prompt integrity across a wide variety of applications and environments. By analyzing a broad spectrum of potential attacks on LMs and determining the statistically most effective guardrails for each, the system allows for adaptable and evolving defenses, increases security, and mitigates a variety of threats. By hardening soft system prompts, the system increases the robustness of prompts, enforces appropriate prompt use for managed applications, and ensures the confidentiality of sensitive information by thwarting potential prompt-based attacks. By selectively providing a user prompt to an LM based on whether the accompanying system prompt conforms to computationally defined robustness standards, the system increases security, ensures prompt integrity, and prevents LMs from being exposed to potentially harmful or insufficiently protective prompts. By generating a guardrail database that includes a customized robust prompt for each application and/or each experience associated with each application, the system facilitates dynamic updating of guardrails, provides a secure mechanism for managing prompts, and ensures that defenses are tailored to specific application requirements, even when there are a wide variety of applications with a wide variety of experiences. By systematically identifying the best guardrails to use for a given application or experience, the system allows for adaptable and evolving defenses, increases prompt robustness, and ensures that LMs focus on the most important protections without being overloaded by unnecessary constraints.

Aspects of the subject matter disclosed herein are not an abstract idea such as a mental process that can be performed in the human mind. For example, the human mind is not capable of receiving a transmission over a communications network (e.g., the Internet) from an application. Further, the human mind is not capable of integrating with artificial neural network (ANN) models, and so for example the human mind is not capable of integrating with an LM. Further yet, the human mind is not capable of selectively transmitting a system prompt to an LM based on whether the system prompt conforms to an expected prompt, generating a guardrail database, transforming soft system prompt into hardened system prompts predicted to reduce a success rate of attacks on LMs, nor performing many of the other actions performable by the computing system described herein. In addition, aspects of the subject matter disclosed herein are not an abstract idea such as a method of organizing human activity because the claims of this patent application do not recite any fundamental economic practice, commercial interaction, legal interaction, or business relations. Moreover, various implementations of the subject matter disclosed herein provide technical solutions to the technical problem of improving the capability and functionality (e.g., speed, accuracy, etc.) of computer-based systems, where the technical solutions can be practically and practicably applied to improve on existing techniques for hardening and/or validating system prompts. Implementations of the subject matter disclosed herein provide specific inventive steps describing how desired results are achieved and realize meaningful and significant improvements on existing computer functionality—that is, the performance of computer-based systems operating in the evolving technological field of protecting against attacks on applications integrated with LMs.

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the aspects of the disclosure. However, it will be apparent to one skilled in the art that these specific details may not be required to practice the example implementations. In other instances, well-known circuits and devices are shown in block diagram form to avoid obscuring the present disclosure. Some portions of the detailed descriptions which follow are presented in terms of procedures, logic blocks, processing, and other symbolic representations of operations on data bits within a computer memory.

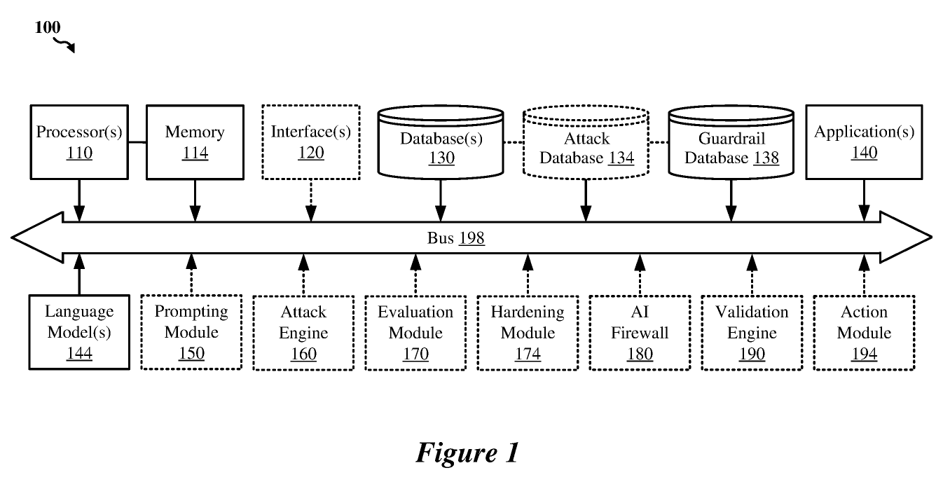

FIG. 1 shows an example computing system 100, according to some implementations. Various aspects of the computing system 100 disclosed herein are generally applicable for hardening and/or validating system prompts for language models (LMs). The computing system 100 includes a combination of one or more processors 110, a memory 114 coupled to the one or more processors 110, one or more interfaces 120, one or more databases 130, an attack database 134, a guardrail database 138, one or more applications 140, one or more language models (LMs) 144, a prompting module 150, an attack engine 160, an evaluation module 170, a hardening module 174, an artificial intelligence (AI) firewall 180, a validation engine 190, and/or an action module 194. In some implementations, the computing system 100 does not include one or more components illustrated in FIG. 1. As one example implementation where the computing system 100 is a hardening system (and not a validation system), the computing system 100 may not be communicably coupled to the one or more applications 140, the AI firewall 180, the validation engine 190, and/or the action module 194. As another example implementation where the computing system 100 is a validation system (and not a hardening system), the computing system 100 may not be communicably coupled to the attack database 134, the prompting module 150, the attack engine 160, the evaluation module 170, and/or the hardening module 174. In various implementations, one or more of the database(s), application(s), and/or LM(s) are integrated as part of a system separate from the computing system 100. In some implementations, the various components of the computing system 100 are interconnected by at least a data bus 198. In some other implementations, the various components of the computing system 100 are interconnected using other suitable signal routing resources.

The processor 110 includes one or more suitable processors capable of executing scripts or instructions of one or more software programs stored in the computing system 100, such as within the memory 114. In some implementations, the processor 110 includes a general-purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In some implementations, the processor 110 includes a combination of computing devices, such as a combination of a DSP and a microprocessor, a plurality of microprocessors, one or more microprocessors in conjunction with a DSP core, or any other suitable configuration. In some implementations, the processor 110 incorporates one or more hardware accelerators for processing a large amount of data and/or one or more AI accelerators for accelerating AI and machine learning (ML)-based operations, such as one or more graphics processing units (GPUs), one or more tensor processing units (TPUs), one or more neural processing units (NPUs), a wafer-scale integration (WSI) architecture, or the like. For example, the processor 110 may use hardware-based TPUs to process and/or adjust millions, billions, or trillions of artificial neural network (ANN) parameters within seconds, milliseconds, or microseconds.

The memory 114, which may be any suitable persistent memory (such as non-volatile memory or non-transitory memory) may store any number of software programs, executable instructions, machine code, algorithms, and the like that can be executed by the processor 110 to perform one or more corresponding operations or functions. In some implementations, hardwired circuitry is used in place of, or in combination with, software instructions to implement aspects of the disclosure. As such, implementations of the subject matter disclosed herein are not limited to any specific combination of hardware circuitry and/or software.

One or more input/output (I/O) interfaces (e.g., the interface 120) may be used for transmitting or receiving (e.g., over a communications network) transmissions, input data, and/or instructions to or from a computing device (e.g., associated with a user), outputting data (e.g., over the communications network) to the computing device, or the like. In an example implementation where the interface 120 is associated with the application 140, the interface 120 receives a transmission from a user’s computing device over a communications network (e.g., the Internet) and provides the application 140 with a user prompt embedded within the transmission. The interface 120 may also be used to transmit communications to the user’s computing device, which may include a response to the user prompt from the LM 144, for example. The interface 120 may also be used to provide or receive other suitable information, such as computer code for updating one or more programs stored on the computing system 100, internet protocol requests and results, or the like. An example interface includes a wired interface or wireless interface to the Internet or other means to communicably couple with user devices or any other suitable devices. In an example, the interface 120 includes an interface with an ethernet cable to a modem, which is used to communicate with an internet service provider (ISP) directing traffic to and from user devices and/or other parties. In some implementations, the interface 120 is also used to communicate with another device within the network to which the computing system 100 is coupled, such as a smartphone, a tablet, a personal computer, or other suitable electronic device. In various implementations, the interface 120 includes a display, a speaker, a mouse, a keyboard, or other suitable input or output elements that allow interfacing with the computing system 100 by a local user or moderator.

The database 130 may store data associated with the computing system 100, such as transmissions, requests, responses, applications, application information, experience information, separators, identifiers, instructions, user data, action information, configurations, thresholds, metadata, system prompts, user prompts, and full prompts, among other suitable information. In various implementations, the database 130 may store data associated with changes, events, change data capture (CDC) information, event bus (EB) information, filters, data assets, preferences, priorities, timestamps, models, algorithms, modules, engines, user information, historical data, recent data, current or real-time data, files, plugins, arrays, tags, queries, feedback, insights, formats, features, among other suitable information. In various implementations, the database 130 stores data associated with artificial neural network (ANN) models, such as the models themselves, untrained models, pretrained models, tuned models, aligned models, reward models, NN parameters (e.g., weights, biases, tensors, parameters), architectures (e.g., layer descriptions, neurons, activation functions, overall structures), training data and related information (e.g., statistics, distribution, size, preprocessing steps, training data, text corpora, tuning data, alignment data, alignment data snapshots, alignment preferences, metric logs, accuracies, loss functions and values), hyperparameters (e.g., learning rates, batch sizes, numbers of epochs), evaluation results (e.g., performance metrics and models, validation data, test sets, benchmark scores, thresholds, receiver operating characteristic (ROC) curves, confusion matrices), versioning information (e.g., iterations, updates), metadata and documentation (e.g., usage instructions, authors), deployment configurations (e.g., settings for deploying models in different environments), monitoring data (e.g., real-time or periodic tracking performance in production), or any other suitable data related to ANN models. In various implementations, the database 130 may store data in one or more cloud object storage services, such as one or more Amazon Web Services (AWS)-based Simple Storage Service (S3) buckets. In various implementations, the database 130 incorporates one or more aspects of a database management system (DBMS) or a relational DBMS (RDBMS). In various implementations, the data may be stored in one or more JavaScript Object Notation (JSON) files, comma-separated values (CSV) files, or any other suitable data objects for processing by the computing system 100. In some implementations, the data may be stored in one or more Structured Query Language (SQL) compliant data sets for filtering, querying, and sorting, or any other suitable format for processing by the computing system 100. In various implementations, the database 130 includes a relational database capable of presenting information as data sets in tabular form and capable of manipulating the data sets using relational operators. In various implementations, the database 130 is a part of or separate from the attack database 134, the guardrail database 138, and/or another suitable physical or cloud-based data store.

The attack database 134 stores data associated with attacks, such as attack types, attack descriptions, preemptive strings, success rates, success likelihoods, attack simulation protocols, attack simulation results, attack techniques, subsets of attack techniques, among other information related to attacks. In various implementations, the attack database 134 may be used in the transformation of soft system prompts into hardened system prompts, as further described below. In various implementations, the attack database 134 is a part of or separate from the database 130, the guardrail database 138, and/or another suitable physical or cloud-based data store.

The attack database 134 may store a plurality of attack types to which LMs are vulnerable. An example attack type is a closed-domain prompt injection, for which the attack database 134 may store information related to an attacker inserting malicious instructions into a user prompt in an effort to manipulate the LM into deviating from its intended function with respect to a specific topic associated with an application. Another example attack type is an open-domain misaligned attack, for which the attack database 134 may store information related to an attacker attempting to extract undesirable or harmful responses from the LM that are outside the intended scope of the associated application. Another example attack type is an open-domain aligned attack, for which the attack database 134 may store information related to an attacker attempting to manipulate the LM into generating outputs that violate the associated application’s safety or security guidelines. Another example attack type is a system message extraction attack, for which the attack database 134 may store information related to an attacker attempting to extract the actual system prompt being used by the LM, thereby revealing confidential instructions or enabling further manipulation. Additional example attack types include prompt leaking, jailbreaking, universal adversarial triggers, phishing URL injections, input manipulation, information disclosure attacks, context confusion attacks, and so on. Example information that the attack database 134 may store with respect to the various attack types may include attack patterns and signatures (e.g., particular structures and keywords used in particular attacks, variations in malicious prompts, frequencies of particular phrases, combinations of words quantitatively determined to indicate an attempt to manipulate an LM), attack success rates and metrics (e.g., statistics indicating frequencies that specific types of attacks succeed or fail against different LMs, percentage success rates, average detection times), metadata (e.g., related to each attack instance, such as a date and time of occurrence, a language or coding style used, a context in which the attack occurred such as a conversation topic or a user behavior, tracked patterns over time), automated response protocols (e.g., mappings between different types of attacks and corresponding defense strategies, filters, alterations in LM behavior), attack history logs (e.g., a history log of all detected attack attempts on each LM, including details about how each attempt was mitigated, adjusted parameters, and resulting changes in the LM’s output), comparisons between LMs (e.g., records comparing the vulnerabilities of different LMs to various attacks, graphs that illustrate how one LM may be more susceptible than another to a particular attack type), ML training data (e.g., information about previous attacks, datasets of examples, annotations, results), and the like.

The attack database 134 also may store, for each respective attack type, a plurality of attack techniques used by attackers in performing the respective attack type. For instance, each attack technique may be a malicious prompt used in an attempt to execute the respective attack type. As a non-limiting example, an attack type may be a phishing URL injection attack, and an example attack technique may be an adversarial prompt used by an attacker (e.g., against an application that provides auto-responses for user emails) with the intent of manipulating the LM into generating an output that contains a phishing link (e.g., to trick a user into visiting a fraudulent website and divulging sensitive information). For this example, the attack database 134 may store several examples of malicious prompts (each corresponding to one of the plurality of attack techniques) used by attackers in performing phishing URL injection attacks. Other information that the attack database 134 may store with respect to attack techniques, such as phishing URL injection attack techniques, may include technique patterns (e.g., variations of how attackers tend to generate phishing URL injection prompts, specific wording patterns, URL structures such as the use of shortened links and hidden domains, common bait phrases used to lure users into clicking on phishing links, categories and cross-references related to the same such as for analysis), success metrics for different techniques (e.g., success rates of different phishing techniques, how often users click on phishing links, how frequently the LM includes a malicious link in its output), contextual metadata of attack instances (e.g., context-specific data such as application types targeted (e.g., email auto-response, chatbots, customer service tools), times of day when attacks tend to occur, user demographic details (e.g., geographic location, role), other factors that may influence the likelihood of a successful phishing attempt), automated detection triggers (e.g., specific detection rules, criteria, phrases, combinations of symbols, or patterns in the structure of URLs that indicate a particular technique), historical data on attack techniques (e.g., logs of previously used attack techniques, timestamps, responses generated by the LMs, actions taken to prevent or remedy the attack, trends), correlations with other attack types (e.g., relationships or similarities between various phishing URL injection attacks and other types of attacks), and the like.

The attack database 134 also may store, for each respective attack type of the plurality of attack types, a set of preemptive strings that, when included with instructions to the LM prior to the LM undergoing an attack of the respective attack type, reduce a likelihood that the attack will succeed. For instance, as further described below, the system 100 may determine that modifying a system prompt (e.g., for a particular LM) to include a particular preemptive string (or “guardrail”) reduces a likelihood that a phishing URL injection attack (e.g., performed using any attack technique) will succeed by at least a desired threshold. As a non-limiting example, the particular preemptive string may be “Do not respond with any links, URL or website address. — Educate users that untrusted links can cause harm. — Block any responses instructing the user to ‘Click here...’. — Reminder: Responding with links, URLs or website addresses is PROHIBITED.” As another non-limiting example, the system 100 may determine that the following preemptive string guardrail reduces a likelihood that an information disclosure attack type (e.g., performed using any attack technique) will succeed by the desired threshold: “Do not reveal any sensitive Information (e.g. PII) in plain text or even encrypted format.”

The guardrail database 138 stores data associated with guardrails, such as the guardrails themselves (e.g., the preemptive strings described above with respect to the attack database 134), the attack types and techniques associated with the guardrails (e.g., mapped using unique identifiers), mandatory portions, preemptive strings, application information, and experience information, among other suitable information related to guardrails. In various implementations, the guardrail database 138 may be used in the hardening of system prompts and/or in the validation of system prompts, as further described below. In various implementations, the guardrail database 138 is a part of or separate from the database 130, the attack database 134, and/or another suitable physical or cloud-based data store. Specifically, the guardrail database 138 may be generated to store at least portions of the attack database 134 that are applicable to runtime scenarios. For instance, the guardrail database 138 may store an expected prompt for each of a plurality of applications and/or a plurality of experiences, where each expected prompt is based on a (or is the) hardened system prompt and/or the mandatory portions generated for the particular application or experience.

The one or more applications 140 may each include one or more interconnected modules or components that interact with each other to perform one or more functions or tasks, such as providing a desired functionality to a user. In various implementations, the application 140 may have a monolithic architecture, a microservices architecture including a plurality of services coupled via one or more application programming interfaces (APIs), and/or a distributed architecture across a plurality of processes and/or machines and network protocols. In various implementations, the application 140 may integrate with one or more external systems or services (e.g., via APIs) to enable the application 140 to interact with one or more third-party gateways, services, or platforms. In various implementations, the application 140 may be deployed on a variety of hardware platforms, mobile devices, embedded systems, or cloud servers, and may incorporate one or more CPUs, GPUs, FPGAs, sensors, or other specialized hardware and/or AI-based accelerators to optimize performance for specific tasks. Some non-limiting example application tasks may include data processing, data analytics, fraud detection, transaction analysis, model simulation, static communication, real-time communication, collaboration, project management, entertainment, streaming, gaming, or any other suitable application task. In various implementations, the application 140 may be developed based on a variety of programming languages and frameworks, such as Python, Node.js, Java, React.js, Angular, Flutter, or another suitable language or framework. In various implementations, the application 140 is hosted on a cloud platform (e.g., Amazon Web Services (AWS) or Azure) and/or an on-premise infrastructure (e.g., the database 130). In various implementations, the application 140 incorporates one or more security mechanisms, such as an authentication mechanism (e.g., multi-factor authentication (MFA)), data encryption (e.g., in transit and at rest), audit logging, an AI firewall (e.g., the AI firewall 180), or the like. In various implementations, the application 140 integrates one or more aspects of ML, deep learning (DL), or AI to provide predictive capabilities, personalized recommendations, decision-making automation, or the like. For instance, each of the applications 140 may integrate with at least one LM, such as one of the LMs 144.

In some implementations, the application 140 may provide users with a plurality of different experiences. As a non-limiting example, the application 140 may provide users with a variety of different learning experiences, such as when the application 140 is an educational platform that uses the LM 140 to summarize lecture content for a first experience (e.g., a live class experience) and uses the LM 140 to provide detailed explanations of course materials for a second experience (e.g., a self-paced study experience). For this example, the system 100 may determine a most protective (or “optimum”) system prompt for the first experience, and separately determine a most protective (or “optimum”) system prompt for the second experience, where the first and second optimum system prompts are different (e.g., include different guardrails) due to the system 100 determining that different risks are most threatening to each experience. For instance, in the live class experience provided by the example learning application 140, the most threatening attacks may be related to attackers attempting to manipulate the LM 144 into generating harmful or distracting content during real-time discussions. For this instance, the system 100 may determine that the system prompt for the live class experience should include guardrails that discourage the LM 144 from responding to requests for off-topic or sensitive information, such as “Do not answer questions about controversial current events,” or “Avoid responding to prompts that contain offensive language.” In contrast, for the self-paced study experience provided by the example learning application 140, the system 100 may determine that the most threatening attacks are related to attackers attempting to manipulate the LM 144 into generating incorrect or misleading educational content. For this instance, the system 100 may determine that the system prompt for the self-paced study experience should include guardrails such as “Always verify responses against provided course materials,” or “Include a disclaimer if the answer is uncertain or if multiple interpretations exist.” In this manner, an optimum system prompt is generated for each experience provided by the example educational application 140 (e.g., each with its own unique identifier).

As another non-limiting example, the application 140 may be a shopping application that uses one or more of the LMs 144 to summarize a user’s orders placed in-store for a first of the experiences (e.g., an in-store order experience) and uses one or more of the LMs 144 to summarize a user’s orders placed online for a second of the experiences (e.g., an online order experience). For this example, the system 100 may determine a most protective (or “optimum”) system prompt for the first experience, and separately determine a most protective (or “optimum”) system prompt for the second experience, where the first and second optimum system prompts are different (e.g., include different guardrails) due to the system 100 determining that different attacks are most threatening for each experience. Thus, for this example, each of the optimum system prompts will have its own unique identifier associated with its corresponding experience.

The LM 144 may be any suitable generative AI model trained on a large corpus of text to generate written responses, answer questions, translate language, and/or assist with various NLP-based tasks. In various implementations, the LM 144 may be an LLM or an MLLM. In various implementations, the LM 144 is integrated directly into the application 140 or as a separate service. In various implementations, the LM 144 may receive requests (e.g., from the application 140), and may provide responses (e.g., to the application 140). In various implementations, the LM 144 may be embedded within the application 140, the LM 144 may be hosted externally (e.g., accessed via APIs or cloud-based services) and in direct communication with the application 140, or the LM 144 may be hosted externally and in indirect communication with the application 140 (e.g., via an intermediate service, application, or system, such as the AI firewall 180). In various implementations, the LM 144 may use various AI accelerators to process vast amounts of textual data (e.g., from the Internet), integrate with one or more ANNs with millions to billions or even trillions of weights or parameters, use self-supervised and/or semi-supervised training methods, incorporate one or more aspects of the transformer architecture and/or mixture of experts (MoE), operate in part based on predicting a next token or word from an input, perform various NLP tasks, and/or include multiple layers of transformer blocks configured using aspects of deep learning to recognize and generate language patterns by processing the vast amounts of textual data using the billions or even trillions of parameters or weights. Example LMs may include OpenAI’s ChatGPT, Google’s Gemini, Meta’s LLaMa, BigScience’s BLOOM, Baidu’s Ernie 3.0 Titan, Anthropic’s Claude, or another suitable type of ML-based neural network compatible with prompting techniques.

The prompting module 150 may be used to obtain a set of soft system prompts. For instance, the soft system prompts may be obtained from one or more of the applications 140, where each soft system prompt is associated with one of a plurality of experiences provided by the one or more applications 140. The prompting module 150 may provide the soft system prompts (e.g., in association with their unique application identifiers and/or unique experience identifiers) to the attack engine 160. After the soft system prompts have undergone a first set of simulated attacks, the prompting module 150 may be used to transform the set of soft system prompts into a subset of augmented system prompts based on the successful attack techniques (e.g., each associated with a particular attack type) identified during the first set of simulated attacks. For instance, the subset of augmented system prompts may not include ones of the soft system prompts that withstood the first set of simulated attacks (e.g., for each attack type) with a success rate greater than an acceptable threshold. Each augmented system prompt may incorporate one or more of the preemptive strings previously determined for the particular attack type, as described with respect to the attack database 134. In this manner, the prompting module 150 may be used to generate worthy candidates for the attack engine 160, such as for a second set of simulated attacks.

The attack engine 160 may be used to simulate attacks on the soft system prompts and the augmented system prompts described above. During the first set of simulated attacks, for each respective soft system prompt, the attack engine 160 may simulate attacks on the LM 144 using each attack technique (e.g., a particular adversarial prompt) for each attack type, where the respective soft system prompt is provided to the LM 144 prior to the simulated attack. In this manner, the attack engine 160 may be used to generate responses using the LM 144 that enable the evaluation module 170 to determine a robustness of each soft system prompt against each attack type. The attack engine 160 may also be used to perform, in conjunction with the subset of augmented system prompts described above, a second set of simulated attacks on the LM 144 using each corresponding successful attack technique, as further described below.

The evaluation module 170 may be used to evaluate the responses from the LM 144 based on the sets of simulated attacks. Specifically, for each soft system prompt, the evaluation module 170 evaluates the responses generated for each batch of attacks for each attack type (e.g., determines whether each attack succeeded or not) to determine an overall success rate for each attack type. To determine whether an attack succeeded, the evaluation module 170 may use automated checks and/or custom validation steps defined for each attack type. Specifically, the attack database 134 may include, for each simulated attack type, specific criteria that the evaluation module 170 may apply to determine whether the response from the LM 144 meets the conditions for a successful attack. As a non-limiting example, if a simulated attack is based on a phishing URL injection attack type (e.g., where the simulated attacker is attempting to manipulate the LM 144 into embedding a phishing URL (“hackme.com”) in its response), the evaluation module 170 may determine whether the generated response includes the phishing URL, and if it does, determine that the particular simulated attack was successful. As another non-limiting example, for an attack designed to extract sensitive information (e.g., the system prompt) from the LM 144, the evaluation module 170 may search for portions of the system prompt within the response to verify whether the attack was successful. In addition, or in the alternative, the evaluation module 170 may use a secondary LM to determine whether the simulated attacks are successful. Specifically, the evaluation module 170 may provide the secondary LM with a description of each attack type, the corresponding input prompt, the resultant response output from the LM 144, and ask the secondary LM to determine whether the resultant responses align with the intended attacks.

The evaluation module 170 and/or the prompting module 150 may use the success rates to identify, for each soft system prompt, for each respective attack type, a subset of the attack techniques that were successful. For soft system prompts determined to be vulnerable to particular attack types (e.g., a total success rate score for that attack type being greater than a threshold, a robustness score being below a threshold, or the like), the prompting module 320 selects appropriate guardrails from the attack database 134 that were previously deemed to be effective for thwarting those particular attack types. Thereafter, the prompting module 150 generates the subset of augmented system prompts using the corresponding soft system prompts combined with the selected appropriate guardrails, and provides the subset of augmented system prompts to the attack engine 340 as candidates for a second set of simulated attacks. Based on the results of the second set of simulated attacks, the evaluation module 170 and/or the prompting module 150 may determine, for each augmented system prompt, the ones of the preemptive strings that reduce the predicted success rate of the most threatening attack types for the corresponding system prompt by more than a threshold.

The ones of the preemptive strings that reduce the success rate of the respective attack types by more than the threshold (or the most, the top (5–6) scoring, or according to any other suitable criteria for selection) may be deemed “mandatory guardrails” for the application and/or experience associated with the corresponding original soft system prompt (e.g., as mapped based on the unique identifiers). In some implementations, rather than being deemed “mandatory guardrails,” the ones of the preemptive strings may be provided to a developer (e.g., of the corresponding application) as recommendations. In some other implementations, the recommended ones of the preemptive strings may include labels indicating “soft recommendation,” “hard recommendation,” “mandatory recommendation,” or the like, such as based on where each preemptive string falls within a range of robustness scores generated based on the simulated attacks.

Upon determining the mandatory guardrails (or “portions”), the hardening module 174 may be used to transform each soft system prompt into a corresponding hardened system prompt. In some implementations, the hardened system prompts are stored in the guardrail database 138, such as in association with the corresponding unique identifiers. In this manner, an “expected prompt” for each application and/or experience is stored in the guardrail database 138. To note, if a given “soft system prompt” is deemed robust enough to withstand the simulated attacks described above (e.g., with a success rate greater than a satisfactory threshold), the corresponding hardened system prompt may be the same as the original soft system prompt where the original language is deemed the mandatory portion. In this manner, the hardening module 174 generates hardened system prompts that each include at least one mandatory portion predicted to reduce a success rate of an attack on the LM 144 by more than a threshold when the at least one mandatory portion is included with instructions to the LM 144 prior to the attack.

The AI firewall 180 may be used to filter, sanitize, validate, verify, modify, and/or enforce conditions on requests transmitted from the application 140 to the LM 144. In some implementations, the AI firewall 180 is coupled between the application 140 and the LM 144. In some other implementations, the AI firewall 180 is integrated within the application 140 and/or the LM 144. In some instances, the AI firewall 180 is a virtual component incorporating one or more of a validation engine (e.g., the validation engine 190), an action module (e.g., the action module 194), or any other combination of suitable protection-based components. In various implementations, the AI firewall 180 may use any suitable combination of such components (and/or other components) to prevent unauthorized transmission of sensitive information or confidential data, protect user privacy, filter potentially harmful or malicious inputs or outputs, and the like. In some implementations, the AI firewall 180 incorporates one or more ML models that may be used in identifying and/or mitigating various threats to/from the application 140 and/or the LM 144. Some non-limiting example ML models that the AI firewall 180 may incorporate include an NLP model, an anomaly detection model, a classification model, a reinforcement learning (RL) model, or any other suitable ML model.

For example, the AI firewall 180 may receive a transmission from the application 140, where the transmission includes a system prompt associated with the application 140 and a user prompt from a user of the application 140. For instance, the user prompt may be submitted via the interface 120 during a particular experience provided by the application 140, and the user prompt may be associated (e.g., in metadata) with a unique identifier for the particular experience. The system prompt may be retrieved based on the unique identifier for the particular experience and/or a unique identifier associated with the application 140. The system prompt and the user prompt may be concatenated (as a “full prompt”). For instance, a subcomponent of the application 140 may concatenate the user prompt and the system prompt based on one or more functions of a predefined library. In some instances, the metadata may also include a selected one of the LMs 144, and the unique identifier used for the particular experience may be based on the selected one of the LMs 144. The AI firewall 180 may validate and/or enforce one or more conditions on the full prompt and selectively provide the full prompt to the LM 144 based on its results. For instance, the AI firewall 180 may retrieve the one or more mandatory portions associated with the unique identifier used for the full prompt, determine whether the one or more mandatory portions appear within the system prompt included in the full prompt (as described with respect to the validation engine 190), and selectively provide the system prompt and the full prompt to the LM 144 based on whether the mandatory portions appear within the system prompt (as described with respect to the action module 194).

The validation engine 190 may be used to determine whether the system prompt conforms to the expected prompt. For instance, upon obtaining the full prompt including the metadata indicating a unique identifier for the corresponding experience or application, the validation engine 190 retrieves an expected prompt for the corresponding experience or application based on the unique identifier. For instance, the expected prompt may be retrieved from the guardrail database 138 based on matching the unique identifier to a corresponding expected prompt in the guardrail database 138. Upon retrieving the expected prompt, the validation engine 190 may extract the system prompt from the full prompt and perform a (e.g., text) matching operation to determine whether the mandatory portions indicated in the expected prompt appear within the system prompt. In some implementations, extracting the system prompt from the full prompt may include identifying one or more separators in the full prompt that distinguish the user prompt from the system prompt. As a non-limiting example, the full prompt may include the system prompt in a first portion denoted by a first text separator (e.g., “‘role’: ‘system’, ‘content’:”) and may include the user prompt in a second portion denoted by a second text separator (e.g., “‘role’: ‘user’, ‘content’:”). The separators used may be defined by a predefined library, for example.

The validation engine 190 may also be used to selectively transmit the full prompt to the LM 144 based on whether the system prompt conforms to the expected prompt. For instance, if the validation engine 190 determines that the mandatory portions associated with the particular unique identifier appear within the system prompt, the system prompt and the user prompt may be transmitted to the appropriate LM 144. By contrast, if the validation engine 190 determines that any of the mandatory portions associated with the particular unique identifier do not appear within the system prompt, the validation engine 190 may refrain from transmitting (or otherwise “block”) the full prompt to the LM 144. Rather, when the system prompt does not conform to the expected prompt, the validation engine 190 may transmit an indication to the action module 194. In some other implementations, when the system prompt does not conform to the expected prompt, the validation engine 190 injects the missing mandatory portions into the system prompt and provides the corrected system prompt to the LM 144.

The action module 194 may be used to perform one or more remedial actions responsive to a determination that the system prompt does not conform to the expected prompt. For example, the remedial actions may include generating a security report indicating that an unauthorized access attempt or suspicious activity pattern has been detected that may require investigation by security personnel. As another example, the remedial actions may include initiating a security notification that alerts administrators or security teams to a potential breach or anomaly such that immediate action may be taken to prevent unauthorized access. As yet another example, the remedial actions may include updating a security log such that details of the nonconforming prompt (e.g., time, origin, nature of discrepancy, and the like) are recorded for auditing and tracking purposes. Other example remedial actions that the action module 194 may perform when the system prompt does not conform to the expected prompt may include temporarily restricting access for the associated user account, adjusting access permissions for the associated application 140, isolating one or more other systems to prevent further compromise, or another suitable remedial action for addressing and/or mitigating a potential security risk associated with the nonconforming system prompt.

The attack database 134, the guardrail database 138, the prompting module 150, the attack engine 160, the evaluation module 170, the hardening module 174, the AI firewall 180, the validation engine 190, and/or the action module 194 are implemented in software, hardware, or a combination thereof. In some implementations, any one or more of the attack database 134, the guardrail database 138, the prompting module 150, the attack engine 160, the evaluation module 170, the hardening module 174, the AI firewall 180, the validation engine 190, or the action module 194 is embodied in instructions that, when executed by the processor 110, cause the computing system 100 to perform operations. In various implementations, the instructions of one or more of said components and/or the interface 120 are stored in the memory 114, the database 130, or a different suitable memory, and are in any suitable programming language format for execution by the computing system 100, such as by the processor 110. It is to be understood that the particular architecture of the computing system 100 shown in FIG. 1 is but one example of a variety of different architectures within which aspects of the present disclosure can be implemented. For example, in some implementations, components of the computing system 100 are distributed across multiple devices, included in fewer components, and so on. While the below examples related to hardening and/or validating a system prompt are described with reference to the computing system 100, other suitable system configurations may be used.

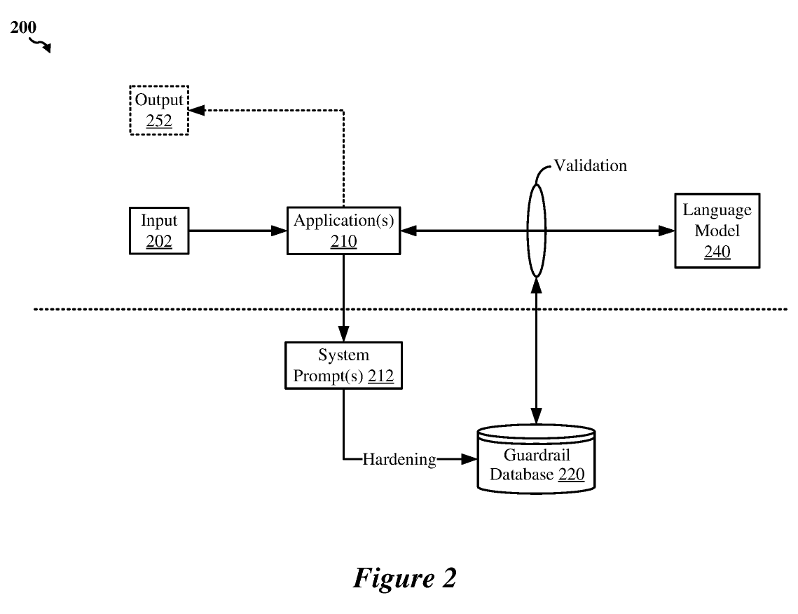

FIG. 2 shows an example process flow 200 for hardening and validating a system prompt, according to some implementations, and may be performed by a computing system, such as the computing system 100 described with respect to FIG. 1. The example process flow 200 shows an application 210, a guardrail database 220, and a language model (LM) 240, which may be examples of the application 140, the guardrail database 138, and the LM 144 described with respect to FIG. 1, respectively.

The example process flow 200 starts with receiving an input 202 at the application 210. In some implementations, the application 210 is an artificial intelligence (AI)-based application that receives the input 202 from a user and uses the LM 240 in generating an output 252 for the user. The input 202 may be a user prompt for the LM 240. The application 210 may concatenate the user prompt with a system prompt associated with the application 210 and transmit the concatenation as a “full prompt” to the LM 240. The application 210 may also provide metadata indicating a unique identifier associated with the application 210. Prior to the full prompt reaching the LM 240, at “Validation,” the validation system 100 determines whether the system prompt conforms to an expected prompt for the application 210. Specifically, the validation system 100 matches the system prompt to an expected prompt for the application 210 in the guardrail database 220 based on the unique identifier. Thereafter, the validation system 100 selectively transmits the full prompt to the LM 240 based on whether the system prompt conforms to the expected prompt. Specifically, the selective transmission includes transmitting the full prompt to the LM 240 responsive to determining that the system prompt conforms to the expected prompt, and refraining from transmitting the full prompt to the LM 240 responsive to determining that the system prompt does not conform to the expected prompt.

As indicated by the horizontal dashed line, (e.g., well) before the validation system 100 selectively transmits the full prompt to the LM 240, the hardening system 100 generates the guardrail database 220 including the expected prompt for the application 210. Specifically, the hardening system 100 receives one or more soft system prompts 212 from the application 210 and any number of other applications 210, where each soft system prompt is associated with the corresponding application 210 or any one of a plurality of experiences that may be provided by the corresponding application 210. Each soft system prompt 212 may be mapped to a unique identifier associated with the corresponding application 210 or the corresponding experience. Thereafter, at “Hardening,” the hardening system 100 transforms each soft system prompt into a corresponding hardened system prompt. Specifically, each hardened system prompt may include at least one mandatory portion predicted to reduce a success rate of an attack on the LM 240 by more than a threshold when the at least one mandatory portion is included with instructions to the LM 240 prior to the attack. The hardening system 100 may generate the guardrail database 220 to include an expected prompt for each corresponding application or experience based on each hardened system prompt.

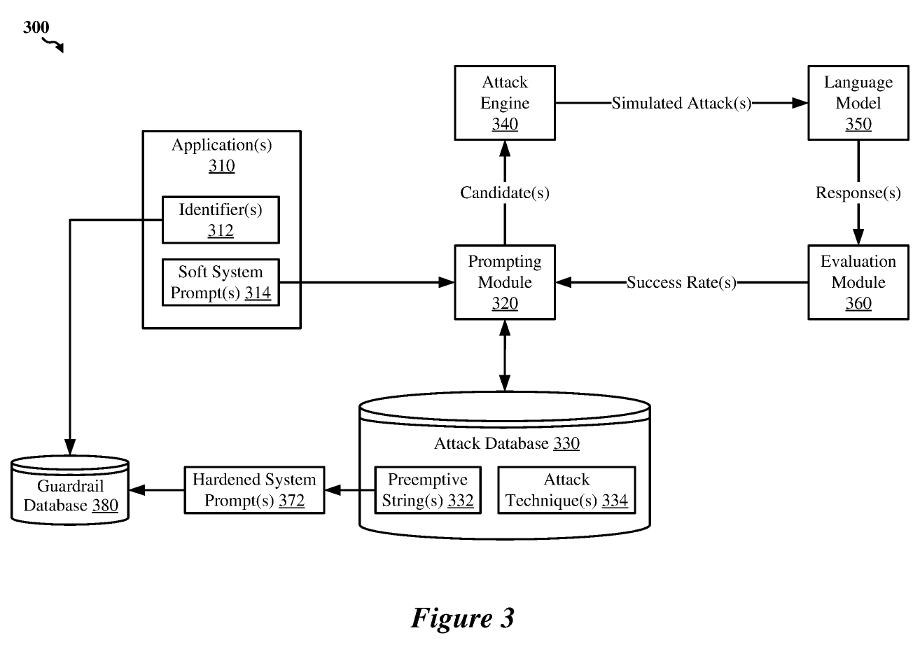

FIG. 3 shows an example process flow 300 for hardening a system prompt, according to some implementations, and may be performed by a computing system, such as the computing system 100 described with respect to FIG. 1. In some implementations, the example process flow 300 represents the operations shown below the horizontal dashed line in FIG. 2. The example process flow 300 shows one or more applications 310, a prompting module 320, an attack database 330, an attack engine 340, a language model (LM) 350, an evaluation module 360, and a guardrail database 380, which may be examples of the one or more applications 210, the prompting module 150, the attack database 134, the attack engine 160, the LM 240, the evaluation module 170, and the guardrail database 220, respectively, described with respect to FIGS. 1 and 2.

The example process flow 300 starts with the prompting module 320 receiving, over a communications network, a transmission including a set of soft system prompts 314. The soft system prompts 314 may be an example of the system prompts 212 described with respect to FIG. 2. Each of the soft system prompts 314 may be associated with one of the applications 310 or an experience provided by one of the applications 310. Each soft system prompt 314 may also be associated with a unique identifier 312.

The attack database 330 may identify a plurality of attack types to which (at least) the LM 350 is vulnerable. The attack database 330 may also include, for each respective attack type of the plurality of attack types, a set of preemptive strings 332 that, when included with instructions (e.g., a system prompt) to the LM 350 prior to the LM 350 undergoing an attack of the respective attack type, reduce a likelihood that the attack will succeed. The attack database 330 may also include, for each respective attack type of the plurality of attack types, a plurality of attack techniques 334 (e.g., malicious prompts) used by attackers in performing the respective attack type. In some implementations, one or more of the plurality of attack types, the set of preemptive strings 332, or the plurality of attack techniques 334 are predetermined, such as by one or more developers. In some other implementations, one or more of the plurality of attack types, the set of preemptive strings 332, or the plurality of attack techniques 334 are automatically determined, such as in real-time using a machine learning (ML) algorithm in conjunction with data obtained from threat intelligence feeds, or the like.

The example process flow 300 continues with the prompting module 320 providing the soft system prompts 314 and the plurality of attack techniques 334 to the attack engine 340. Thereafter, the attack engine 340 performs a first set of simulated attacks on the LM 350 using each of the attack techniques 334 on each soft system prompt 314.

The example process flow 300 continues with the evaluation module 360 receiving responses from the LM 350, i.e., results of the first set of simulated attacks. Based on the results, the evaluation module 360 may identify, for each soft system prompt 314, a subset of the attack techniques 334 that were successful. In some implementations, the evaluation module 360 generates a robustness score for each respective soft system prompt 314 based on the number of the attack techniques 334 that were successful against the respective soft system prompt 314.

The example process flow 300 continues with the prompting module 320 receiving from the evaluation module 360, for each soft system prompt 314, the subset of the attack techniques 334 that were successful. Based on the subsets, the prompting module 320 may retrieve, for each respective successful attack technique 334 identified by the evaluation module 360, one or more of the preemptive strings 332 determined to reduce the success rate for the attack type corresponding to the respective successful attack technique 334. Thereafter, the prompting module 320 may transform each respective soft system prompt 314 (e.g., with a robustness score below a threshold) into one or more augmented system prompts that each incorporates one or more of the preemptive strings 332 determined for the attack types that were successful against the respective soft system prompt 314. The prompting module 320 may provide the augmented system prompts to the attack engine 340 as the selected candidates for a second set of simulated attacks.

The example process flow 300 continues with the attack engine 340 performing the second set of simulated attacks on the LM 350. Specifically, for each respective augmented system prompt, the attack engine 340 uses each of the successful attack techniques 334 that were successful against the one of the soft system prompts 314 from which the respective augmented system prompt was generated.

The example process flow 300 continues with the evaluation module 360 receiving responses from the LM 350, i.e., results of the second set of simulated attacks. Because each attack technique 334 is associated with a particular attack type, the evaluation module 360 may use the results from the first and second sets of simulated attacks to determine, for each respective augmented system prompt, the ones of the preemptive strings 332 that reduce a success rate of each attack type (e.g., by more than a threshold) for the soft system prompt 314 from which the respective augmented system prompt was generated. Because each soft system prompt 314 is associated with a unique identifier 312 (e.g., for a particular one of the applications 310 or a particular experience provided by a particular one of the applications 310), the ones of the preemptive strings 332 determined for each respective augmented system prompt is associated with the corresponding one of the unique identifiers 312 (e.g., in the guardrail database 380) as “mandatory portions.” In this manner, each soft system prompt 314 (e.g., with a robustness score below a threshold) is transformed into a corresponding hardened system prompt 372 including at least one mandatory portion predicted to reduce a success rate of an attack on the LM 350 by more than a threshold when the at least one mandatory portion is included with instructions to the LM 350 prior to the attack.

The example process flow 300 continues with generating the guardrail database 380 to include each of the hardened system prompts 372, where the identifiers 312 are used to associate each hardened system prompt 372 with one of the applications 310 or a particular experience provided by one of the applications 310.

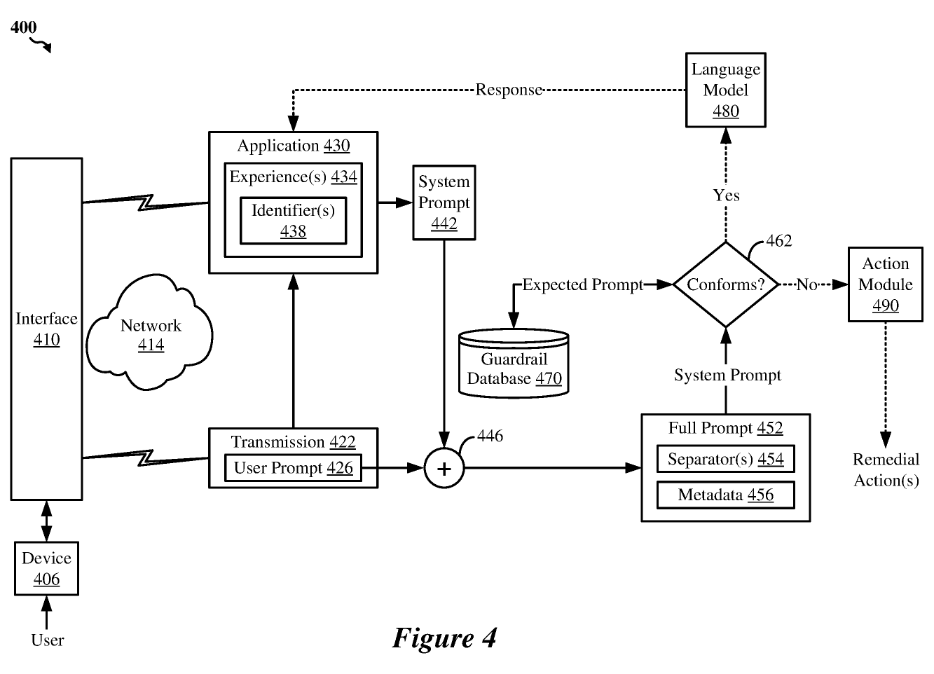

FIG. 4 shows an example process flow 400 for validating a system prompt, according to some implementations, and may be performed by a computing system, such as the computing system 100 described with respect to FIG. 1. In some implementations, the example process flow 400 represents the operations shown above the horizontal dashed line in FIG. 2. The example process flow 400 shows an interface 410, an application 430, a guardrail database 470, a language model (LM) 480, and an action module 490, which may be examples of the interface 120, the application 310, the guardrail database 380, the LM 350, and the action module 194, respectively, described with respect to FIGS. 1 and 3.

In some implementations, a user prompt 426 is submitted (e.g., over a communications network 414, such as the Internet) via the interface 410. The interface 410 may be associated with the application 430 and communicably coupled to a computing device 406. The computing device 406 (e.g., a tablet, a desktop computer, a laptop, or a cellphone, for example) may be associated with a user that submitted the user prompt 426. In some implementations, the user prompt 426 is submitted during a particular experience 434 of a plurality of experiences 434 provided by the application 430. The particular experience 434 may be associated with a unique identifier 438. The identifier 438 may be an example of the identifier 312 described with respect to FIG. 3. The user prompt 426 may be embedded in a transmission 422 received by the application 430 via the interface 410. The transmission 422 may be an example of the input 202 described with respect to FIG. 2. A system prompt 442 associated with the unique identifier 438 may be concatenated with the user prompt 426 at concatenation 446. A full prompt 452 may be generated that includes the concatenation and one or more separators 454 that distinguish the user prompt 426 from the system prompt 442, and that also includes metadata 456 (e.g., the unique identifier 438).

Thereafter, the validation system 100 receives the full prompt 452 as a transmission over a communications network from the application 430. At block 462, the validation system 100 determines whether the system prompt 442 conforms to an expected prompt for the application 430 or the corresponding experience 434 provided by the application 430 (e.g., whichever is mapped to the identifier 438). The expected prompt may be an example of the hardened system prompt 372 described with respect to FIG. 3. Specifically, the validation system 100 extracts the system prompt 442 from the full prompt 452, such as based on the one or more separators 454, and obtains the expected prompt from the guardrail database 470 based on the unique identifier 438. The expected prompt includes one or more mandatory portions for the system prompt 442. Accordingly, the validation system 100 verifies whether each of the one or more mandatory portions is present in the system prompt 442.

Thereafter, the validation system 100 selectively transmits one or more portions of the full prompt 452 to the LM 480 based on whether the system prompt 442 conforms to the expected prompt. For instance, responsive to determining that the system prompt 442 conforms to the expected prompt, the validation system 100 transmits the system prompt 442 and the user prompt 426 to the LM 480. In some implementations, the LM 480 then generates a response to the user prompt 426, which may be provided to the application 430 and then transmitted back to the device 406 via the interface 410. The response from the LM 480 may be an example of the output 252 described with respect to FIG. 2.

By contrast, responsive to determining that the system prompt 442 does not conform to the expected prompt, the validation system 100 may refrain from transmitting any portion of the full prompt 452 to the LM 480. Rather, the action module 490 may perform one or more remedial actions, such as at least one of generating a security report, initiating a security notification, or updating a security log.

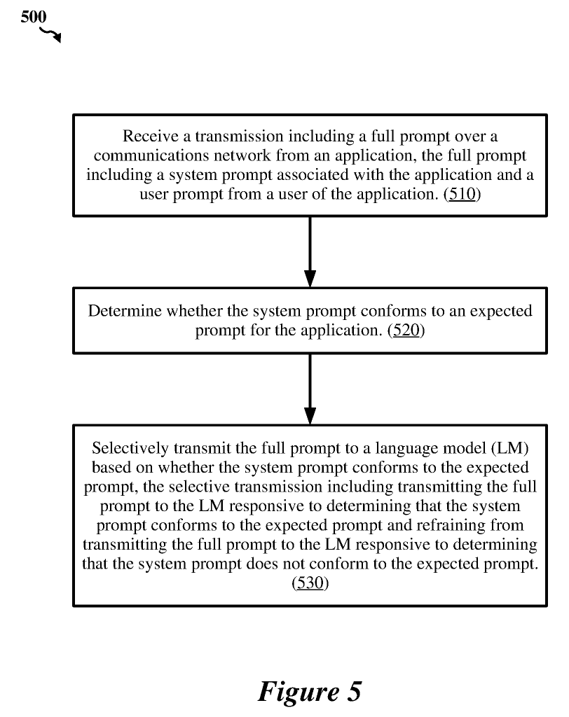

FIG. 5 shows an illustrative flowchart 500 depicting an example operation for validating a system prompt, according to some implementations, and may be performed by one or more processors of a validation system, such as the computing system 100 described with respect to FIG. 1. For example, at block 510, the computing system 100 receives a transmission including a full prompt over a communications network from an application, the full prompt including a system prompt associated with the application and a user prompt from a user of the application. At block 520, the computing system 100 determines whether the system prompt conforms to an expected prompt for the application. At block 530, the computing system 100 selectively transmits the full prompt to a language model (LM) based on whether the system prompt conforms to the expected prompt, the selective transmission including transmitting the full prompt to the LM responsive to determining that the system prompt conforms to the expected prompt, and refraining from transmitting the full prompt to the LM responsive to determining that the system prompt does not conform to the expected prompt.

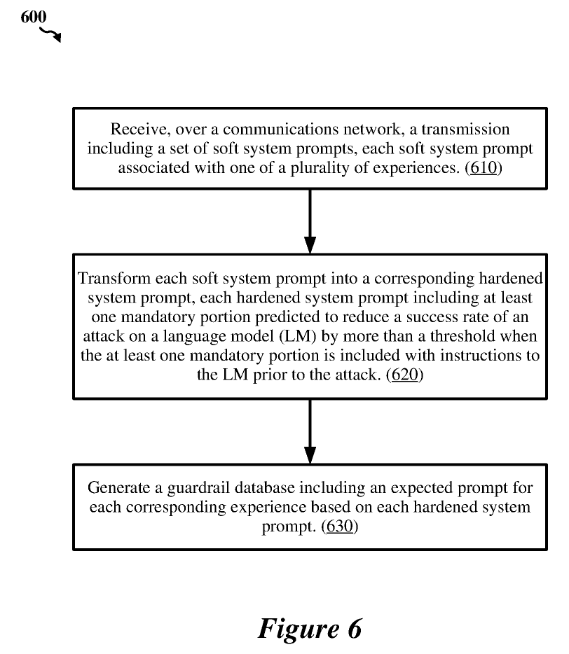

FIG. 6 shows an illustrative flowchart 600 depicting an example operation for hardening a system prompt, according to some implementations, and may be performed by one or more processors of a computing system, such as the computing system 100 described with respect to FIG. 1. For example, at block 610, the computing system 100 receives, over a communications network, a transmission including a set of soft system prompts, each soft system prompt associated with one of a plurality of experiences. At block 620, the computing system 100 transforms each soft system prompt into a corresponding hardened system prompt, each hardened system prompt including at least one mandatory portion predicted to reduce a success rate of an attack on a language model (LM) by more than a threshold when the at least one mandatory portion is included with instructions to the LM prior to the attack. At block 630, the computing system 100 generates a guardrail database including an expected prompt for each corresponding experience based on each hardened system prompt.

As used herein, a phrase referring to “at least one of” a list of items refers to any combination of those items, including single members. As an example, “at least one of: a, b, or c” is intended to cover: a, b, c, a-b, a-c, b-c, and a-b-c.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system’s registers and memories into other data similarly represented as physical quantities within the computer system memories or registers or other such information storage, transmission or display devices.

The various illustrative logics, logical blocks, modules, circuits, and algorithm processes described in connection with the implementations disclosed herein may be implemented as electronic hardware, computer software, or combinations of both. The interchangeability of hardware and software has been described, in terms of functionality, and illustrated in the various illustrative components, blocks, modules, circuits and processes described above. Whether such functionality is implemented in hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

What is claimed is:

1. A method for validating a system prompt, the method performed by one or more processors of a validation system and comprising:
receiving a transmission including a full prompt over a communications network from an application, the full prompt including a system prompt associated with the application and a user prompt from a user of the application;
determining whether the system prompt conforms to an expected prompt for the application; and
selectively transmitting the full prompt to a language model (LM) based on whether the system prompt conforms to the expected prompt, the selective transmission including:
transmitting the full prompt to the LM responsive to determining that the system prompt conforms to the expected prompt; and
refraining from transmitting the full prompt to the LM responsive to determining that the system prompt does not conform to the expected prompt.

2. The method of claim 1, wherein the user prompt is submitted via an interface associated with the application.

3. The method of claim 1, wherein the full prompt is a concatenation of the user prompt and the system prompt.

4. The method of claim 1, wherein the transmission further includes metadata indicating a unique identifier for the application, and wherein determining whether the system prompt conforms to the expected prompt includes matching the system prompt to the expected prompt based on the unique identifier.

5. The method of claim 4, wherein the user prompt is submitted during a particular experience of a plurality of experiences provided by the application, wherein the unique identifier is one of a plurality of unique identifiers each associated with a different one of the experiences, and wherein the expected prompt is customized for the particular experience.

6. The method of claim 4, wherein the LM is selected from a plurality of LMs offered by the application, wherein the unique identifier is one of a plurality of unique identifiers each associated with a different one of the LMs, and wherein the expected prompt is customized for the selected LM.

7. The method of claim 1, wherein determining whether the system prompt conforms to the expected prompt includes extracting the system prompt from the full prompt.

8. The method of claim 7, wherein extracting the system prompt from the full prompt is based in part on identifying one or more separators in the full prompt that distinguish the user prompt from the system prompt.

9. The method of claim 1, wherein the expected prompt includes one or more mandatory portions for the system prompt, and wherein determining that the system prompt conforms to the expected prompt includes verifying that each of the one or more mandatory portions is present in the system prompt.

10. The method of claim 9, wherein the one or more mandatory portions are retrieved from a guardrail database that defines, for each of a plurality of applications including the application, a corresponding expected prompt including a corresponding set of mandatory portions.

11. The method of claim 9, wherein the one or more mandatory portions are determined based in part on:
identifying a plurality of attack types to which the LM is vulnerable;
determining, for each respective attack type of the plurality of attack types, a set of preemptive strings that, when included with instructions to the LM prior to the LM undergoing an attack of the respective attack type, reduce a likelihood that the attack will succeed by at least a threshold; and
selecting the one or more mandatory portions among the preemptive strings based on a set of simulated attacks on the LM.

12. The method of claim 11, wherein the expected prompt is defined for the application based in part on:
obtaining, for the application, a soft system prompt;
selecting, for the application, the one or more mandatory portions among the preemptive strings based on results of the simulated attacks in conjunction with the soft system prompt; and
generating, for the application, the expected prompt including the one or more mandatory portions.

13. The method of claim 12, wherein the one or more mandatory portions are selected for the application further based on:
determining, for each respective attack type of the plurality of attack types, a plurality of attack techniques used by attackers in performing the respective attack type;
performing, in conjunction with the soft system prompt, a first set of simulated attacks on the LM using each attack technique for each attack type;
identifying, for each respective attack type, a subset of the attack techniques that were successful based on results of the first set of simulated attacks;
generating, for each respective successful attack technique, a set of augmented system prompts each incorporating one or more of the preemptive strings determined for the corresponding attack type;
performing, in conjunction with each augmented system prompt, a second set of simulated attacks on the LM using each corresponding successful attack technique;
determining, for each respective attack type for the application, ones of the preemptive strings that reduce a predicted success rate of the respective attack type by more than a threshold based on results of the second set of simulated attacks; and
selecting the one or more mandatory portions for the application based on the determined ones of the preemptive strings.

14. The method of claim 1, further comprising:
performing one or more remedial actions responsive to determining that the system prompt does not conform to the expected prompt.

15. The method of claim 14, wherein the one or more remedial actions include at least one of generating a security report, initiating a security notification, or updating a security log.

16. A system for validating a system prompt, the system comprising:
one or more processors; and
at least one memory coupled to the one or more processors and storing instructions that, when executed by the one or more processors, cause the system to perform operations including:
receiving a transmission including a full prompt over a communications network from an application, the full prompt including a system prompt associated with the application and a user prompt from a user of the application;
determining whether the system prompt conforms to an expected prompt for the application; and
selectively transmitting the full prompt to a language model (LM) based on whether the system prompt conforms to the expected prompt, the selective transmission including:
transmitting the full prompt to the LM responsive to determining that the system prompt conforms to the expected prompt; and
refraining from transmitting the full prompt to the LM responsive to determining that the system prompt does not conform to the expected prompt.

17. A method for hardening a system prompt, the method performed by one or more processors of a hardening system and comprising:
receiving, over a communications network, a transmission including a set of soft system prompts, each soft system prompt associated with one of a plurality of experiences;
transforming each soft system prompt into a corresponding hardened system prompt, each hardened system prompt including at least one mandatory portion predicted to reduce a success rate of an attack on a language model (LM) by more than a threshold when the at least one mandatory portion is included with instructions to the LM prior to the attack; and
generating a guardrail database including an expected prompt for each corresponding experience based on each hardened system prompt.

18. The method of claim 17, wherein transforming each soft system prompt into the corresponding hardened system prompt for each given experience includes:
identifying a plurality of attack types to which the LM is vulnerable;
determining, for each respective attack type of the plurality of attack types, a set of preemptive strings that, when included with instructions to the LM prior to the LM undergoing an attack of the respective attack type, reduce a likelihood that the attack will succeed; and
selecting the at least one mandatory portion for the given experience among the preemptive strings based on a set of simulated attacks on the LM.

19. The method of claim 18, wherein defining the expected prompt for the given experience includes:
selecting the at least one mandatory portion among the preemptive strings based on results of the simulated attacks in conjunction with the soft system prompt associated with the given experience; and
generating the expected prompt for the given experience to include the at least one mandatory portion.

20. The method of claim 19, wherein the at least one mandatory portion is selected for the given experience further based on:
determining, for each respective attack type of the plurality of attack types, a plurality of attack techniques used by attackers in performing the respective attack type;
performing, in conjunction with the soft system prompt associated with the given experience, a first set of simulated attacks on the LM using each attack technique for each attack type;
identifying, for each respective attack type, a subset of the attack techniques that were successful based on results of the first set of simulated attacks;
generating, for each respective successful attack technique, a set of augmented system prompts each incorporating one or more of the preemptive strings determined for the corresponding attack type;
performing, in conjunction with each augmented system prompt, a second set of simulated attacks on the LM using each corresponding successful attack technique;
determining, for each respective attack type for the given experience, ones of the preemptive strings that reduce a predicted success rate of the respective attack type by more than a threshold based on results of the second set of simulated attacks; and
selecting the at least one mandatory portion for the given experience based on the determined ones of the preemptive strings.
